(19) United States
(12) Patent Application Publication
(10) Pub. No.: US 2002/0047244 A1
(43) Pub. Date: Apr. 25, 2002

(54) Rear axle for a motor vehicle

(76) Inventors: Stefan Behrens, Hilgert (DE); Edison Fatehpour, Koblenz (DE)

Correspondence Address: LERNER AND GREENBERG, P.A., Post Office Box 2480, Hollywood, FL, 33022-2480, US

(21) Appl. No.: 09/946,864

(22) Filed: Sep. 4, 2001

Related U.S. Application Data
(63) Continuation of application No. PCT/EP00/01887, filed on Mar. 3, 1999.

(30) Foreign Application Priority Data
Mar. 4, 1999 (DE) 199 09 561.2

(51) Int. Cl. B60G 1/00

(52) U.S. Cl. 280/124.11

(57) ABSTRACT

A rear axle of a motor vehicle has a guide rod assembly. The guide rod assembly is constructed from two wheel-bearing trailing links which run parallel to one another and are joined together in the area of the ends furthest away from the wheels by a cross member that is rigid, yet has a high degree of torsional flexibility. Two swivel bearings, which are located at a certain distance from one another are provided for mounting the guide rod assembly on the motor vehicle body. The guide rod assembly is mounted on the motor vehicle body by an essentially vertical lever arm to avoid a longitudinal displacement of the rear axle despite the non-rigid design of the bearing.

### BACKGROUND OF THE INVENTION

### FIELD OF THE INVENTION

The present invention relates to a rear axle for a motor vehicle that includes a linkage with two wheel-mounting trailing arms, which are joined together by a transverse strut in the region of wheel-remote end portions thereof. The linkage is pivoted to the vehicle body by means of two bearings spaced apart from each other.

One such rear axle is known from published German Patent Application DE 43 22 910 A1. Linkage-located rear axles have been in use in large numbers on motor vehicles for many years. In this arrangement, the axle bearings form the connections between the vehicle body and the axle that determines the vehicle response and ride. This is the reason why a compromise needs to be made between stable road-holding and ride in configuring the bearing points of the road wheel location parts.

For a safe vehicle reaction a stiff location arrangement, for example, by a ball bearing, would be ideal. However, for a comfortable ride the fore-and-aft spring stiffness of the axle bearings needs to be maintained as small as possible.

### SUMMARY OF THE INVENTION

It is accordingly an object of the invention to provide a rear axle which overcomes the above-mentioned disadvantageous of the prior art apparatus of this general type. In particular, it is an object of the invention to provide a rear axle of the aforementioned kind, which avoids fore-and-aft displacements of the bearing points on cornering for a low fore-and-aft stiffness.

With the foregoing and other objects in view there is provided, in accordance with the invention, a rear axle for a motor vehicle, that includes a linkage with two wheel-mounting trailing arms. Each of the two-wheel mounting trailing arms has a first end portion for mounting a wheel and a second end portion remote from the first end portion. The rear axle also includes: a transverse strut joined to the second end portion of each of the two-wheel mounting trailing arms; a substantially vertically orientated lever arm for pivotably connecting the transverse strut to a body of a motor vehicle; and two bearings located spaced apart from each other and including an elastomeric bush. The two bearings connect the linkage and the lever arm. The lever arm is pivotable about a fulcrum located below the second end portion of each one of the trailing arms.

In accordance with an added feature of the invention: the elastomeric bush is fixedly attached to the linkage; the elastomeric bush includes an elastomeric bearing body; and the lever arm includes a pin pivotably attaching the elastomeric bearing body to the body of the motor vehicle.

In accordance with an additional feature of the invention, the rear axle includes stops assigned to the bush. The stops act fore-and-aft for limiting displacement of the bearings.

In accordance with another feature of the invention, the stops are configured as stopper buffers spaced apart from each other and cooperating with the pin.

In accordance with a further feature of the invention, the rear axle includes a pin. The elastomeric bush includes an elastomeric bearing body supporting the pin. The elastomeric bush is pivotally connected to the body of the vehicle. The bearing includes a fork fixedly attached to the linkage, and the fork includes arms connected by the pin.

In accordance with a further added feature of the invention, the rear axle includes a pivotal bearing for pivotably attaching the bush to the body of the vehicle.

In accordance with a further additional feature of the invention, the rear axle includes a slider guide for connecting the bush to the body of the vehicle.

In accordance with yet an added feature of the invention, the slider guide is formed with at least one guide groove for engaging the pin.

The objects of the invention are achieved by mounting the linkage to the vehicle body by a substantially vertically orientated lever arm.

This makes it possible to configure the rear axle location very soft fore-and-aft since the fore-and-aft displacements of the bearing points occurring on cornering are compensated by the lever arm of the pivot due to a combined-effect motion. This combined-effect motion results from the springy-displacement of the outside road wheel and the rebound of the inside road wheel that automatically exists on cornering, the lever arm then resulting in a fore-and-aft displacement in the opposite direction. In this arrangement, pivoting of the lever arm is required to occur below the wheel-remote end portions of the trailing arm. The lever arm of the pivot is smaller than the lever arm of the linkage, thus making it possible to design the bearings soft by compensating the fore-and-aft displacement in the rear axle.

When the wheel-remote ends of the trailing arms are mounted by means of pins, these pins need to pivot relative to the vehicle body, the pivot fulcrum being located below the wheel-remote end of the corresponding trailing arm.

Advantageously, the bearing includes an elastomeric bush, the housing of which is fixedly defined by the linkage and whose elastomeric bearing body is pivotedly attached by a pin to the vehicle body. The spacing of the pin connecting the vehicle body acts as the lever arm.

The bearing may include a fork fixedly attached to the linkage. The arms of the fork are connected by a pin that is supported by the elastomeric bearing body of an elastomeric bush that is pivotally connected to the vehicle body. In this aspect, too, a second lever arm is achieved for linking the rear axle. This combination of a fork orientated vertically to the linkage and a pin passing through the bearing in turn permits compensating the fore-and-aft motion by a combined-effect motion.

Other features which are considered as characteristic for the invention are set forth in the appended claims.

Although the invention is illustrated and described herein as embodied in a rear axle for a motor vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a plan view of a rear axle;

FIG. 2 is a side view of the rear axle in the direction of the arrow II as shown in FIG. 1;

FIGS. 3a-c are diagrams illustrating various prior art rear axle designs and how they react in left-hand cornering;

FIG. 4 is a diagram illustrating the force relationships in the inventive rear axle;

FIGS. 5a-d are diagrams illustrating the axle location in accordance with FIG. 2 in the region of the right-hand vehicle side for various driving conditions;

FIGS. 6a-d are diagrams illustrating the axle location in accordance with FIG. 2 in the region of the left-hand vehicle side for various driving conditions;

FIGS. 7a-d are diagrams illustrating the axle location in accordance with FIG. 2 for various driving conditions;

FIG. 8 is a side view of a further embodiment of the rear axle;

FIG. 9 is a side view of another embodiment of the rear axle;

FIGS. 10a-d are diagrams illustrating the second embodiment of the rear axle for various driving conditions; and

FIGS. 11a-d are diagrams illustrating the third embodiment of the rear axle for various driving conditions.

### DESCRIPTION OF THE PREFERRED EMBODIMENTS

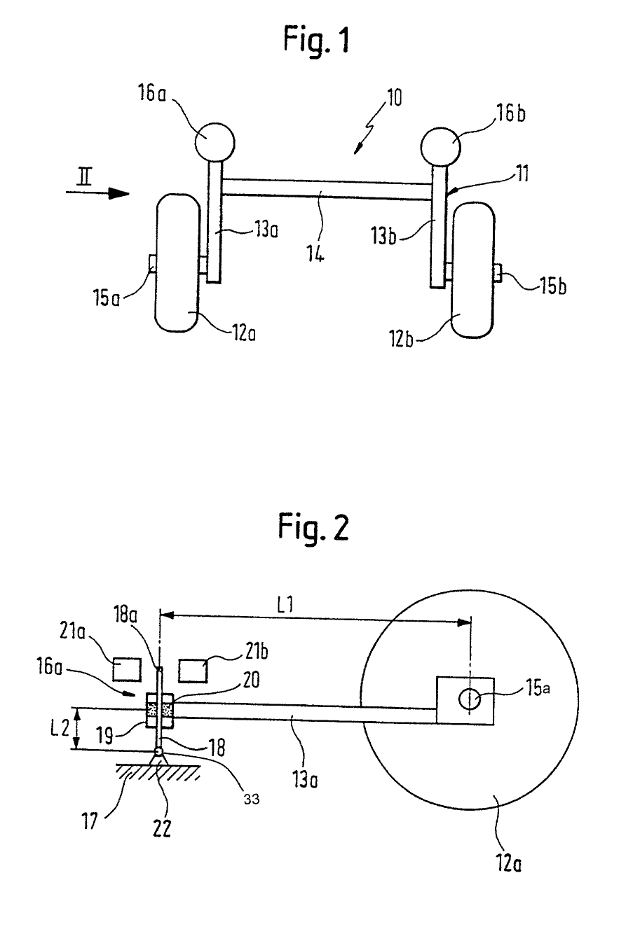

Referring now to the figures of the drawing in detail and first, particularly, to FIG. 1 thereof, there is shown a plan view of the rear axle 10 in accordance with the invention as employed on a motor vehicle (not shown). The rear axle 10 includes a linkage 11 made up of two trailing arms 13a, 13b that are parallel to each other and a transverse strut 14 that connects the two trailing arms 13a, 13b. Each of the trailing arms 13a, 13b is configured flexurally and torsionally rigid, whereas the transverse strut 14 is configured tensile and compressively rigid but torsionally pliant.

The rear wheels 12a, 12b are mounted at respective end portions of the trailing arms 13a, 13b by means of axle shafts 15a, 15b. The opposite ends of the trailing arms 13a, 13b of the linkage 11 are mounted to the vehicle body 17 (not shown) by the bearings 16a, 16b.

Referring now to FIG. 2, there is illustrated a side view of the rear axle in the direction of the arrow II as shown in FIG. 1. As evident from this illustration, the bearing 16a includes an elastomeric bush 19 incorporating a elastomeric bearing body 20. The elastomeric bush 19 is attached to the free end of the trailing arm 13a. A pin 18 penetrates the elastomeric bush 19 and is held by the elastomeric bearing body 20. A first end portion of the pin 18 is pivoted to the vehicle body by means of a pivotal or swivel bearing 22. The pin 18 forms a lever arm L2 between the swivel bearing 22 at the body end and the middle of the elastomeric bearing body 20.

The pin 18 can be swiveled about a fulcrum 33 relative to the vehicle body 17. This fulcrum 33 is located below the end of the trailing arm 13a that is remote from the wheel 12a.

The pin 18 includes an elongated portion 18a extending beyond the elastomeric bush 19. This elongated portion 18a cooperates with stops 21a, 21b that are spaced apart from each other for restricting the fore-and-aft motion of the rear axle 10.

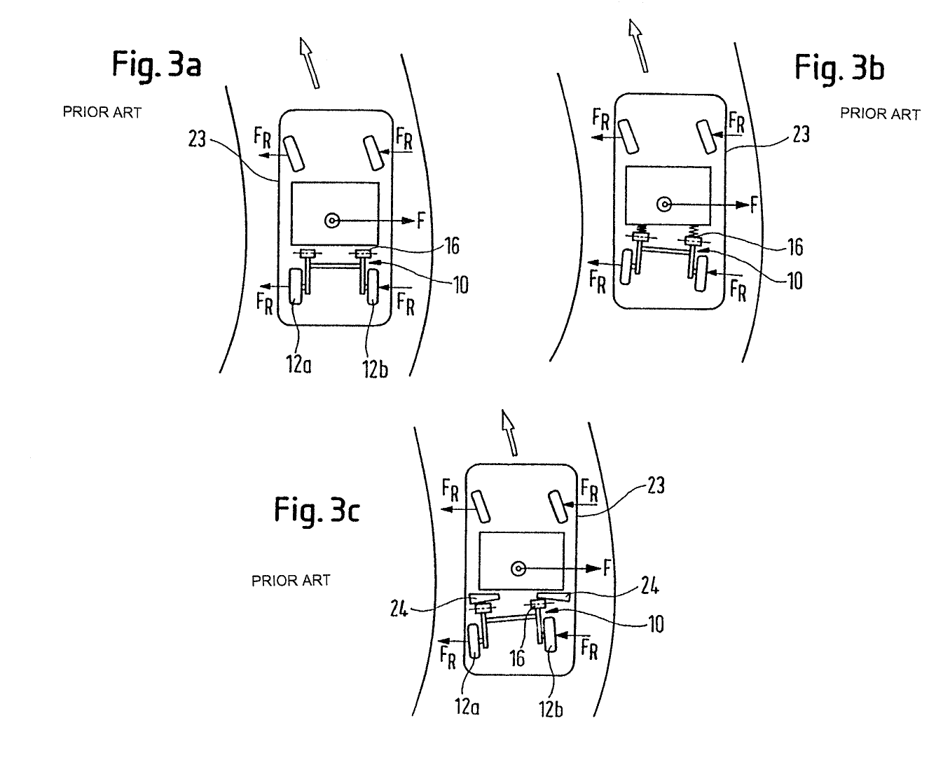

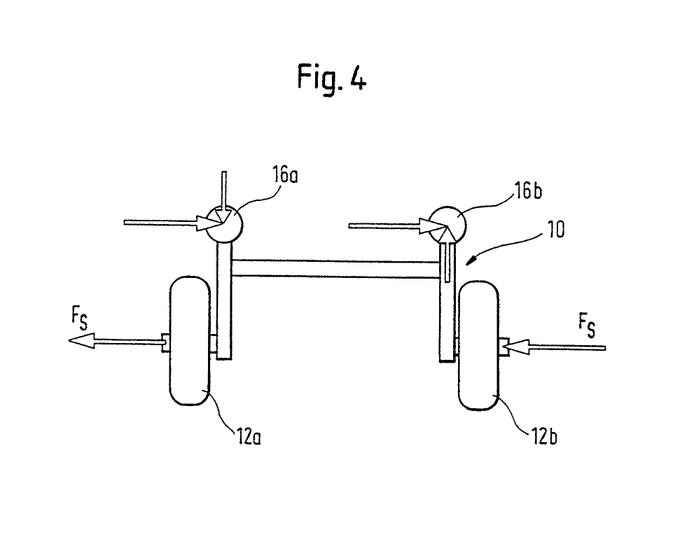

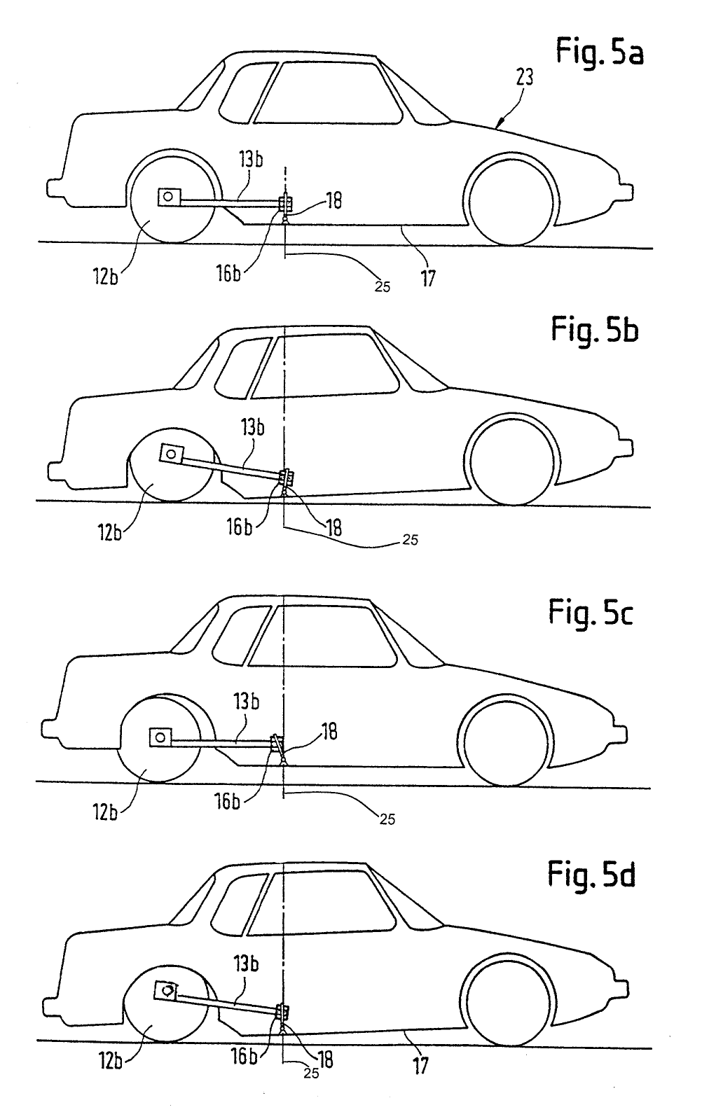

Before explaining the functioning of the rear axle 10 as shown in FIGS. 1 and 2 the problem solved by the invention will first be detailled with reference to the FIGS. 3 and 4. FIGS. 3a to 3c depict various types of known rear axles and their reaction in left-hand cornering.

Referring now to FIG. 3a there is illustrated a rear axle having a neutral reaction in left-hand cornering. As evident from the diagrammatic illustration, the vehicle 23 includes a rear axle 10 mounted in bearings 16. In left-hand cornering a centrifugal force F occurs directed outwardly, resulting in the reaction forces F_{R} at the rear wheels 12a, 12b. In the rear axle location, as shown, the neutral reaction is achieved by the bearings 16 being configured very stiff, ideally as ball bearings. This has the disadvantage that the riding comfort is reduced by the stiff mounting in the fore-and-aft direction.

Referring now to FIG. 3b there is illustrated a rear axle 10 mounted to the vehicle body by bearings 16 incorporating rubber bushes. This kind of location results in a tendency to oversteer, prompting veering of the vehicle 23.

In the rear axle configured as shown in FIG. 3c, understeer occurs. Each of the bearings 16 includes a wedge 24, which translates the deflection of the rear axle 10 into the desired fore-and-aft direction. The disadvantage in this arrangement is that the rear axle 10 needs to be soft mounted laterally to permit any lateral displacement relative to the vehicle 23 at all.

FIG. 4 illustrates the relationship between the forces in the region of the bearings 16a, 16b of the rear axle 10 when exposed to the forces Fₛ.

The functioning of the bearing configuration at the rear axle 10 as shown in FIG. 2 will now be explained with reference to the FIGS. 5a to 5d.

Referring now to FIG. 5a, there is illustrated the right-hand side of a vehicle 23 on which the rear axle 10 is in the normal position, the bearing 16b being located on the normal axis 25.

FIG. 5d depicts the reaction in a rear axle 10 in accordance with the invention in left-hand cornering, resulting in a combination of the effects as shown at the right-hand vehicle side in FIGS. 5b and 5c in compensating the resulting fore-and-aft motions.

FIG. 5b depicts the fore components of the fore-and-aft displacement resulting from the process of the deflection of the offside road wheel and the existing lever arm.

FIG. 5c depicts the aft displacement of the rear axle resulting from support of the side forces at the offside road wheel.

It is to be noted that neither the effect as shown in FIG. 5b nor that as shown in FIG. 5c occurs by itself in the rear axle 10 in accordance with the invention.

As evident from FIG. 5d no displacement of the bearing 16b occurs relative to the normal axis 25. Despite the soft fore-and-aft response of the bearing 16b, the fore-and-aft motion is compensated by the combined effect of motion resulting from pivoting action of the bearings 16b by an interposed pin 18.

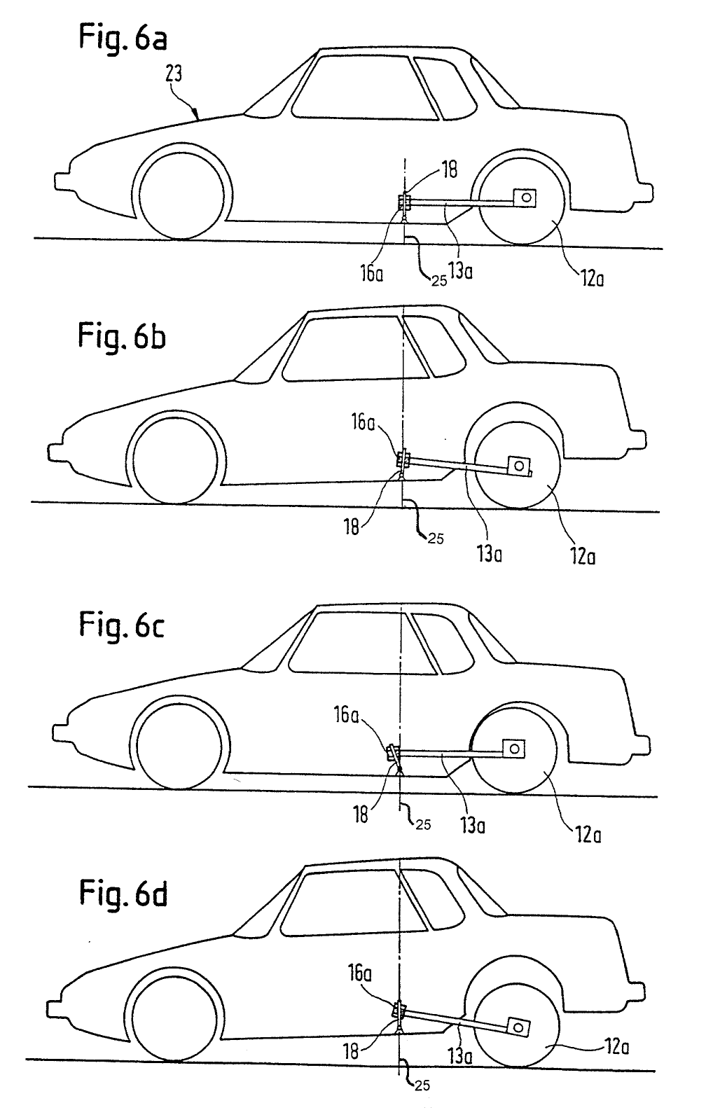

FIGS. 6a to 6b illustrate the reaction in each case that exists on the left-hand side of the vehicle for the driving conditions shown in FIGS. 5a to 5d.

In FIG. 6d it is evident that no displacement relative to the normal axis 25 also occurs in the region of the left-hand side, due to a compensation of the motions as shown in FIGS. 6b and 6c.

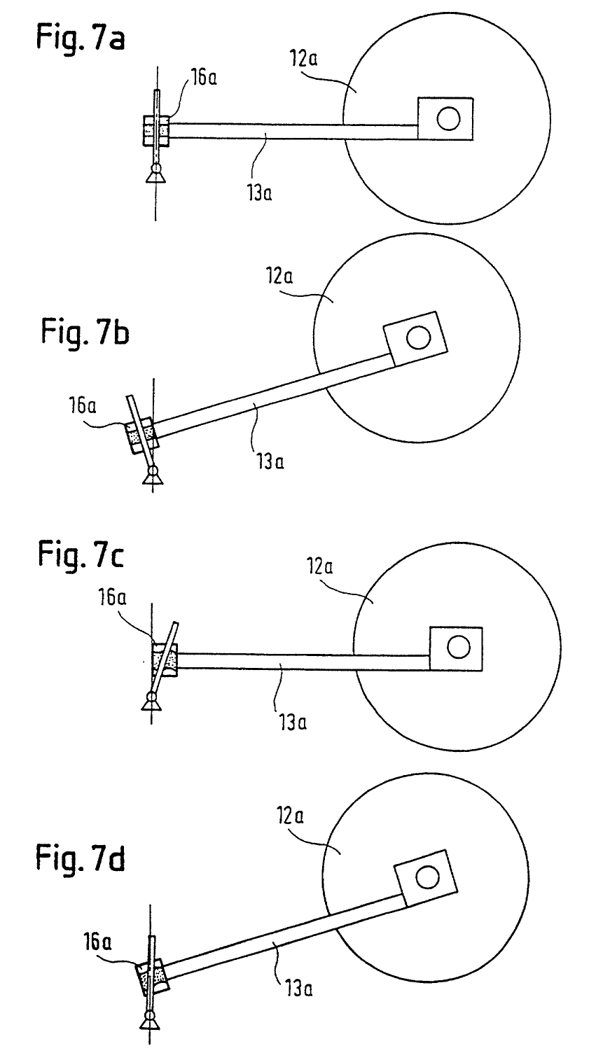

Referring now to FIGS. 7a to 7d each of the conditions shown in FIGS. 5a to 5d is now depicted on a magnified scale. It is particularly clear from FIG. 7d how, despite the soft design of the bearing 16a, no fore-and-aft displacement occurs since this is compensated on cornering by a combined-effect motion.

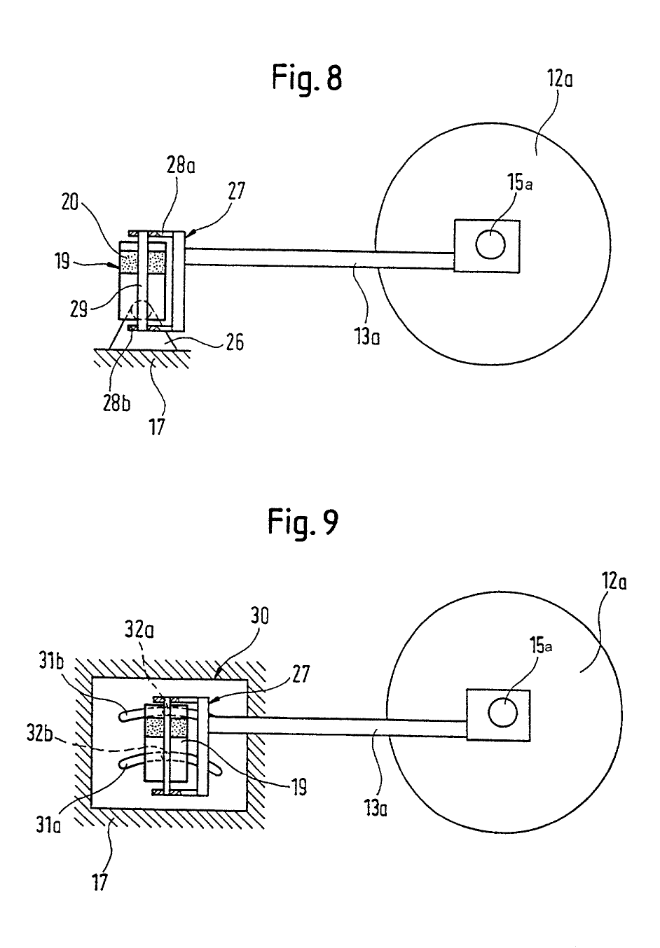

Referring now to FIG. 8, there is illustrated a further aspect in which the trailing arms 13a, 13b of the rear axle 10 each include a fork 27 at their respective ends. The fork 27 is orientated perpendicular to the longitudinal centerline of the trailing arm 13a. Two fork arms 28a, 28b spaced apart from each other are connected by a pin 29, which passes through the elastomeric bush 19 and at the outer circumference of which the elastomeric bearing body 20 is disposed. The elastomeric bush 19 is pivoted with respect to the vehicle body 17 by means of a pivotal bearing 26.

In this location too, a pivot is provided with a lever arm (L2), resulting in compensation of fore-and-aft motions by a combined-effect motion. The fulcrum 33 of the pin 29 is located below the wheel-remote end portions of the trailing arm 13a.

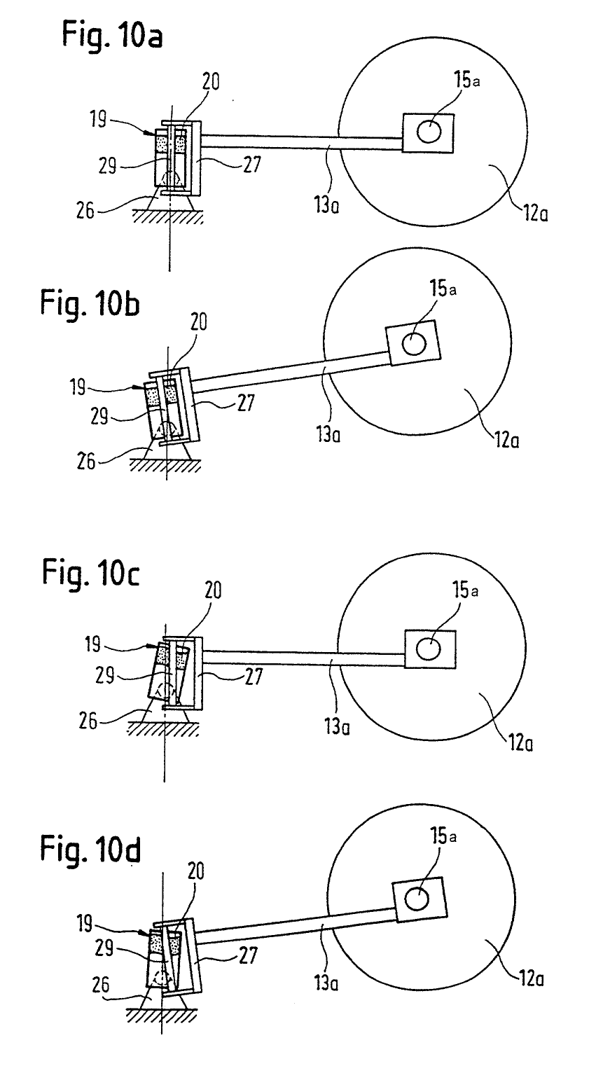

FIGS. 10a to 10d illustrate how the rear axle reacts in the region of the right-hand side of the vehicle shown in FIGS. 5a to 5d. FIG. 10d shows how no fore-and-aft displacement occurs due to the motions being combined in effect.

FIG. 9 illustrates a further aspect similar to that shown in FIG. 8 in which pivoting with respect to the vehicle body 17 is achieved by a slider guide. The slider guide 30 includes parallel curved guide grooves 31a, 31b engaged by guide pins 32a, 32b that are held in position by the bush 19, and thereby enable pivoting of the bush 19 with respect to the vehicle body 17. This enables the virtual fulcrum 33 to be relocated further downwards without sacrificing ground clearance. The fulcrum 33 is located below the wheel-remote end portions of the trailing arm 13a.

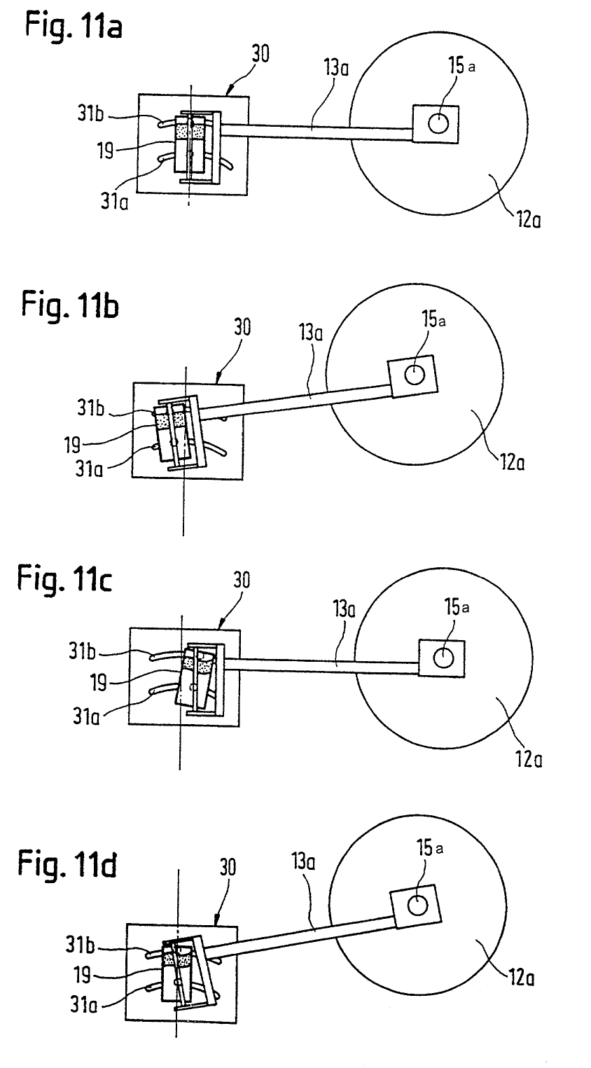

FIGS. 11a to 11d illustrate an aspect in which no fore-and-aft displacement occurs due to the fore-and-aft motion being compensated by a combined-effect motion.

We claim:

1. A rear axle for a motor vehicle, comprising:
a linkage including two wheel-mounting trailing arms, each of said two-wheel mounting trailing arms having a first end portion for mounting a wheel and a second end portion remote from said first end portion;
a transverse strut joined to said second end portion of each of said two-wheel mounting trailing arms;
a substantially vertically orientated lever arm for pivotably connecting said transverse strut to a body of a motor vehicle; and
two bearings located spaced apart from each other and including an elastomeric bush, said two bearings connecting said linkage and said lever arm;
said lever arm being pivotable about a fulcrum located below said second end portion of each one of said trailing arms.

2. The rear axle according to claim 1, wherein:
said elastomeric bush is fixedly attached to said linkage;
said elastomeric bush includes an elastomeric bearing body; and
said lever arm includes a pin pivotably attaching said elastomeric bearing body to the body of the motor vehicle.

3. The rear axle according to claim 2, comprising stops assigned to said bush, said stops acting fore-and-aft.

4. The rear axle according to claim 3, wherein said stops are configured as stopper buffers spaced apart from each other and cooperating with said pin.

5. The rear axle according to claim 1, comprising:
a pin;
said elastomeric bush including an elastomeric bearing body supporting said pin, said elastomeric bush being pivotally connected to the body of the vehicle;
said bearing includes a fork fixedly attached to said linkage; and
said fork including arms connected by said pin.

6. The rear axle according to claim 5, comprising a pivotal bearing for pivotably attaching said bush to the body of the vehicle.

7. The rear axle according to claim 6, comprising a slider guide for connecting said bush to the body of the vehicle.

8. The rear axle according to claim 7, wherein said slider guide is formed with at least one guide groove for engaging said pin.
